(19) United States
(12) Patent Application Publication
(10) Pub. No.: US 2026/0188810 A1
(43) Pub. Date: Jul. 2, 2026

(54) BATTERY PACK, BATTERY SYSTEM INCLUDING THE SAME, AND BATTERY PACK MANUFACTURING METHOD

(71) Applicant: SK ON CO., LTD., Seoul (KR)

(72) Inventors: Ji San KIM, Daejeon (KR); Shan Shan JIN, Daejeon (KR); Sun Ho JANG, Daejeon (KR)

(21) Appl. No.: 19/373,760

(22) Filed: Oct. 30, 2025

(30) Foreign Application Priority Data
Dec. 31, 2024 (KR) 10-2024-0202189

(51) Int. Cl. H01M 50/213; H01M 10/0587; H01M 10/613; H01M 10/6557; H01M 10/658; H01M 50/289; H01M 50/342; H01M 50/367; H01M 50/383

(52) U.S. Cl. CPC H01M 50/213; H01M 10/0587; H01M 10/613; H01M 10/6557; H01M 10/658; H01M 50/289; H01M 50/3425; H01M 50/367; H01M 50/383; H01M 2220/20

(57) ABSTRACT

A battery pack includes a cell assembly including a first cell array and a second cell array, respectively including a plurality of battery cells arranged in a row, a pack housing accommodating the cell assembly, a pack cover covering the cell assembly, and an insulating member disposed to contact a side surface of the battery cell between the first cell array and the second cell array, wherein the insulating member is separated from the pack housing.

### CROSS-REFERENCE TO RELATED APPLICATIONS

This patent document claims the priority and benefits of Korean Patent Application No. 10-2024-0202189 filed on Dec. 31, 2024, the disclosure of which is incorporated herein by reference in its entirety.

### TECHNICAL FIELD

The disclosure and implementations disclosed in this patent document generally relate to a battery pack, a battery system including the same, and a method of manufacturing a battery pack.

### BACKGROUND

Secondary batteries, unlike primary batteries, are conveniently charged with and discharged of electricity, and therefore have come to prominence as a power source for various mobile devices and electric vehicles. Rechargeable and dischargeable secondary batteries, unlike primary batteries, have been applied to a wide range of applications, including digital cameras, mobile phones, laptops, hybrid vehicles, electric vehicles, and energy storage systems (ESS).

Such secondary batteries may include battery cells, each of which includes an electrode assembly, which is formed by stacking a positive electrode plate, a negative electrode plate, and a separator or winding them into a roll and accommodated within a case. A plurality of battery cells may be stacked in a predetermined direction and accommodated in a battery assembly, such as a battery module or battery pack.

### SUMMARY

Related art batteries were difficult to disassemble and recycle at the end of their service life. In particular, the potting material injected to provide structural support and prevent thermal runaway of battery cells made disassembly of the battery cells difficult.

Furthermore, related art battery systems had the problem of unnecessary weight increases due to the overlapping configuration of the battery pack and the body.

The present disclosure may be implemented in some embodiments to provide a battery pack with improved recyclability.

The present disclosure may also be implemented in some embodiments to provide a structurally simplified battery system.

The battery pack, the battery system including the same, and the method of manufacturing the battery pack of the present disclosure may be widely applied to devices within green technology fields, such as electric vehicles, battery charging stations, and other solar and wind power generation using batteries. Furthermore, the battery pack, the battery system including the same, and the method of manufacturing the battery pack of the present disclosure may be used in eco-friendly electric vehicles, hybrid vehicles, and other vehicles that prevent climate change by suppressing air pollution and greenhouse gas emissions.

In some embodiments of the present disclosure, a battery pack includes: a cell assembly including a first cell array and a second cell array, respectively including a plurality of battery cells arranged in a row; a pack housing accommodating the cell assembly; a pack cover covering the cell assembly; and an insulating member disposed to contact a side surface of a battery cell of the plurality of battery cells between the first cell array and the second cell array, wherein the insulating member is separated from the pack housing.

The insulating member may be spaced apart from the pack housing.

The battery cell may include a first edge adjacent to a terminal portion on one side of the battery cell and a second edge located on the other side of the battery cell, the side surface of the battery cell may include a first region adjacent to the first edge, a second region adjacent to the second edge, and a third region located between the first region and the second region, and the insulating member may be disposed in the third region.

The cell assembly may include a first separation space formed between the first cell array and the second cell array, and the insulating member may be disposed in the first separation space.

The battery pack may further include: an intervening member disposed between the pack housing and the cell assembly, wherein the insulating member is separated from the intervening member.

The pack housing may include a venting portion discharging gas generated inside the battery cell externally, and the intervening member may include a notch groove.

The pack housing may include a bottom plate and a plurality of side plates extending from an edge of the bottom plate toward the pack cover, and the venting portion may include a venting hole formed on one surface of the bottom plate and a venting flow path formed between one surface and the other surface of the bottom plate.

The battery pack may further include: at least one cooling members cooling the cell assembly, wherein the first cell array and the second cell array are arranged to be in contact with the at least one cooling member.

The cooling member may be disposed to contact the side surface of the battery cell between the first cell array and the second cell array.

The battery cell may include a first edge adjacent to a terminal portion on one side of the battery cell and a second edge located on the other side of the battery cell, the side surface of the battery cell may include a first region adjacent to the first edge, a second region adjacent to the second edge, and a third region located between the first region and the second region, the cooling member may be disposed in the third region, and the insulating member may be disposed in at least one of the first region and the second region.

The battery pack may further include: an extinguishing member disposed inside the pack housing and extinguishing a fire in the battery cell.

The extinguishing member may include: a case including an accommodation space; and an extinguishing agent accommodated in the accommodation space.

The cell assembly further may include a third cell array including a plurality of battery cells and disposed adjacent to the second cell array and a second separation space formed between the second cell array and the third cell array, and the extinguishing member may be disposed in the second separation space.

The insulating member may include an insulating and non-curing material.

In some embodiments of the present disclosure, a method of manufacturing a battery pack includes: a second cell array preparation operation of arranging a plurality of battery cells to prepare a second cell array; an insulating member arrangement operation of disposing an insulating member on a side surface of the plurality of battery cells included in the second cell array; a first cell array preparation operation of arranging a plurality of battery cells on the insulating member to prepare a first cell array; and an insulating member pressing operation of pressing the insulating member.

The insulating member may be disposed in a first separation space formed between the first cell array and the second cell array.

The insulating member pressing operation may reduce a gap between the first cell array and the second cell array.

The method may further include: a cooling member and extinguishing member installation operation of installing a cooling member cooling the plurality of battery cells and an extinguishing member extinguishing a fire in the plurality of battery cells.

In some embodiments of the present disclosure, a battery system includes: a battery pack; and a body forming a passenger compartment, wherein the battery pack may include a cell assembly including a first cell array and a second cell array, respectively including a plurality of battery cells arranged in a row, a pack housing accommodating the cell assembly, a pack cover covering the cell assembly, and an insulating member disposed to contact a side surface of the plurality of battery cells between the first cell array and the second cell array, wherein the insulating member may be separated from the pack housing, and the pack cover may be provided as at least a portion of the body.

The cell assembly may include a first separation space formed between the first cell array and the second cell array, and the insulating member may be disposed in the first separation space.

### BRIEF DESCRIPTION OF DRAWINGS

Certain aspects, features, and advantages of the present disclosure are illustrated by the following detailed description with reference to the accompanying drawings.

FIG. 1 is a perspective view of a battery pack according to an embodiment;

FIG. 2 is an exploded perspective view of a battery pack according to an embodiment;

FIG. 3 is an exploded perspective view of a battery cell according to an embodiment;

FIG. 4 is a top plan view of a battery pack without a pack cover according to an embodiment;

FIG. 5 is a side view of a battery cell and an insulating member according to an embodiment;

FIG. 6 is a top plan view of a battery pack without a pack cover according to another embodiment;

FIG. 7 is a side view of a battery cell, an insulating member, and a cooling member according to another embodiment;

FIG. 8 is a partial cross-sectional view of a battery pack when an event occurs;

FIGS. 9A to 9E are cross-sectional views of a bottom plate according to various embodiments;

FIG. 10 is a flowchart of a method of manufacturing a battery pack according to an embodiment;

FIG. 11 is a schematic diagram illustrating a method of manufacturing a battery pack according to an embodiment; and

FIG. 12 is a side view of a battery system according to an embodiment.

### DETAILED DESCRIPTION

The same reference numerals or symbols respectively illustrated in the attached drawings denote parts or elements that perform the actually same functions. For convenience of description and understanding, the parts or elements will be described by using the same reference numerals or symbols even in different embodiments. In other words, although elements having the same reference numerals are all illustrated in a plurality of drawings, the plurality of drawings do not mean an embodiment.

As used herein, the singular forms are intended to include the plural forms as well, unless the context clearly indicates otherwise. It will be further understood that the terms “comprises,” “comprising,” etc. when used in this specification, specify the presence of stated features, integers, steps, operations, elements, and/or components, but do not preclude the presence or addition of one or more other features, integers, steps, operations, elements, components, and/or groups thereof.

In addition, in the present specification, expressions, such as an upper side, a lower side, a side face, a rear surface, and the like, are described based on the drawings and may be expressed differently when the direction of the corresponding object is changed.

The terms including ordinal numbers, such as ‘first’, ‘second’, etc. may be used herein to distinguish elements from one another. These ordinal numbers are merely used to distinguish the same or similar elements from one another, and meanings of the terms are not construed as being limited by the using of the ordinal numbers. For example, use orders or arrangement orders of elements combined with these ordinal numbers are not limited by numbers thereof. The ordinal numbers may be redisposed with one another.

Hereinafter, the present disclosure will be described in detail with reference to the accompanying drawings. However, this is merely illustrative and the present disclosure is not limited to the specific embodiments described by way of example.

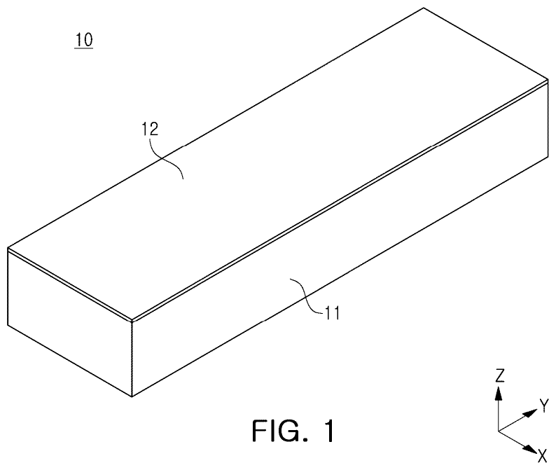

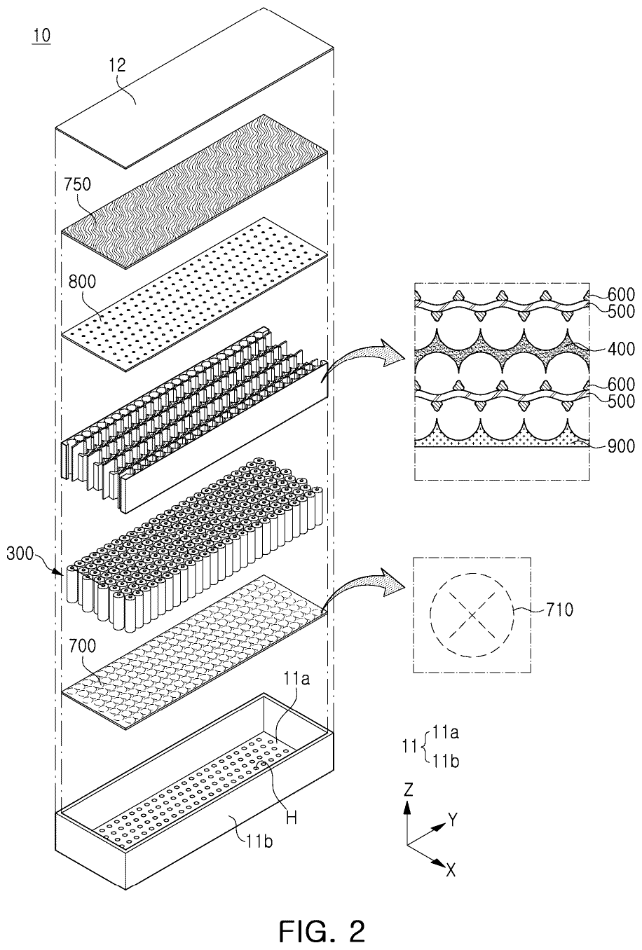

FIG. 1 is a perspective view of a battery pack 10 according to an embodiment. FIG. 2 is an exploded perspective view of the battery pack 10 according to an embodiment.

Referring to FIGS. 1 and 2, the battery pack 10 according to an embodiment of the present disclosure may include a cell assembly 300 including a first cell array 201 and a second cell array 202, respectively including a plurality of battery cells 100 arranged in a row, a pack housing 11 accommodating the cell assembly 300, and a pack cover 12 covering the cell assembly 300.

The cell array 200 may include a plurality of battery cells 100 arranged in a row. The battery cells 100 may be configured as secondary batteries. For example, the battery cell 100 may be configured as a lithium secondary battery, a nickel-cadmium battery, a nickel-metal hydride battery, a nickel-hydrogen battery, etc.

The battery cell 100 may be configured as a can-shaped secondary battery in which an electrode assembly is accommodated within a rigid cell case. Can-shaped secondary batteries may be classified as cylindrical secondary batteries and prismatic secondary batteries depending on an external shape thereof. In the present disclosure, although a cylindrical secondary battery is described as the battery cell 100, the battery cell 100 does not exclude prismatic secondary batteries.

Arranging a plurality of battery cells 100 in a row may mean that the plurality of battery cells 100 are arranged in a first direction (e.g., the Y-axis direction of FIG. 2), while standing in a third direction (e.g., the Z-axis direction of FIG. 2). That is, the cell array 200 may include the plurality of battery cells 100 arranged in a row. In the following description, the direction in which the battery cells 100 are arranged is referred to as the first direction (the Y-axis direction, hereinafter referred to as “Y”), and a height direction of the battery cells 100 is referred to as the third direction (the Z-axis direction, hereinafter referred to as “Z”).

The cell assembly 300 may include a plurality of cell arrays 200. The plurality of cell arrays 200 may each form a row. For example, the cell assembly 300 may include a first cell array 201 and a second cell array 202. The first cell array 201 and the second cell array 202, respectively including the plurality of battery cells 100, may be arranged in a second direction (e.g., the X-axis direction of FIG. 2), perpendicular to the first direction. In the following description, the direction in which the cell array 200 is arranged is referred to as the second direction (the X-axis direction, hereinafter referred to as “X”).

The pack housing 11 forms an arrangement space for accommodating the cell assembly 300. Therefore, the pack housing 11 may accommodate the cell assembly 300. The pack housing 11 may protect the cell assembly 300 accommodated in the arrangement space from an external environment.

The pack housing 11 may include a bottom plate 11a and a plurality of side plates 11b extending from the edge of the bottom plate 11a toward the pack cover 12. The bottom plate 11a and the plurality of side plates 11b may be manufactured separately and then coupled together by welding or the like. Alternatively, at least some of the bottom plate 11a and the side plates 11b may be formed integrally.

The pack cover 12 may be coupled to the pack housing 11 to cover the cell assembly 300. Various methods, such as welding, may be used to couple the pack cover 12 to the pack housing 11.

An insulating member 400 may be disposed between the first cell array 201 and the second cell array 202 and contact a side surface of the battery cell 100. Therefore, the insulating member 400 may prevent heat transfer between the cell arrays 200. The first cell array 201 and the second cell array 202 may be defined as cell arrays 200 disposed on both sides of the insulating member 400.

The insulating member 400 may be separated from the pack housing 11. Specifically, the insulating member 400 may be separated from the bottom plate 11a of the pack housing 11. Therefore, when the battery is disassembled, the cell assembly 300 may be easily disassembled from the pack housing 11.

“The insulating member 400 may be separated from the pack housing 11” may mean “The insulating member 400 may be in detachable contact with the pack housing 11” or “The insulating member 400 may be spaced apart from the pack housing 11.” A case in which the insulating member 400 is in detachable contact with the pack housing 11 may mean that the insulating member 400 is formed of a non-cured, non-adhesive material so that the insulating member 400 may contact the pack housing 11 but is easily detachable. Alternatively, the insulating member 400 may be formed of a liquid, non-adhesive, insulating material. For example, the insulating member 400 may include at least one of a form in which aerogel particles are included in a liquid medium (e.g., water or silicone oil), a form in which ceramic particles (e.g., aluminum oxide, silica, zirconia) are included in a liquid medium (e.g., water or silicone oil), or a foamed liquid insulating material (e.g., polyurethane).

Hereinafter, a case in which the insulating member 400 is spaced apart from the pack housing 11 is illustrated as an example, but a case in which the insulating member 400 is in detachable contact with the pack housing 11 is not excluded.

The insulating member 400 may be spaced apart from the pack housing 11 in the third direction. Specifically, the insulating member 400 may be spaced apart from the bottom plate 11a of the pack housing 11 in the third direction. Therefore, the insulating member 400 may be easily disassembled from the pack housing 11.

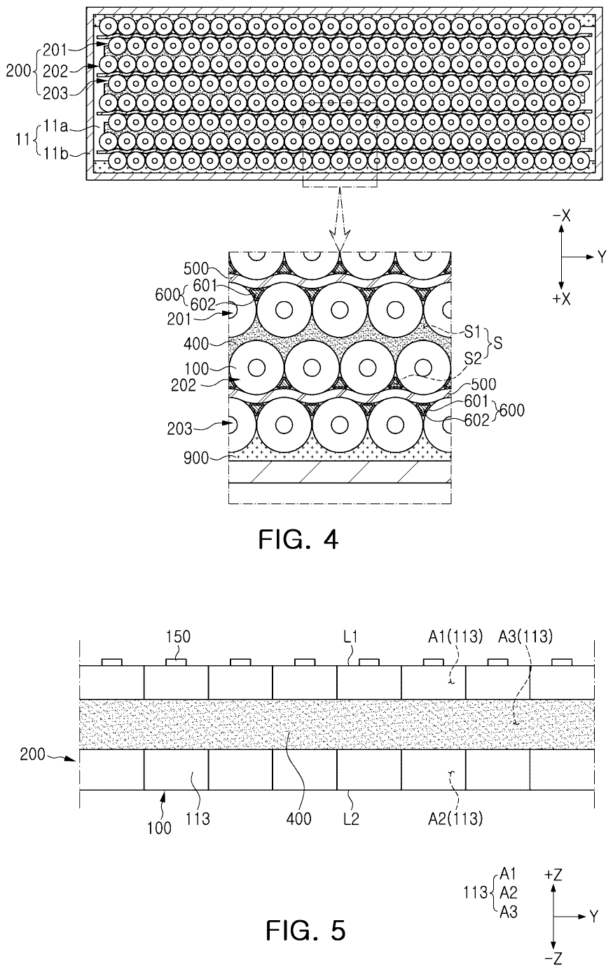

Details of the insulating member 400 will be described below with reference to FIGS. 4 and 5.

According to an embodiment, the battery pack 10 may further include at least one cooling member 500 cooling the cell assembly 300. The first cell array 201 and the second cell array 202 may be arranged to contact the at least one cooling member 500. Specifically, the cooling member 500 may be disposed at least either between the first cell array 201 and one cell array 200 adjacent to the first cell array 201 or between the first cell array 201 and another cell array 200 adjacent to the first cell array 201 to contact the first cell array 201.

Similarly, the cooling member 500 may be disposed at least either between the second cell array 202 and one cell arrays 200 adjacent to the second cell array 202 or between the second cell array 202 and another cell array 200 adjacent to the second cell array 202 to contact the second cell array 202.

Details of the cooling member 500 will be described below with reference to FIGS. 4 to 7.

According to an embodiment, the battery pack 10 may further include an extinguishing member 600 disposed inside the pack housing 11 and configured to extinguish a fire in the battery cells 100.

The cell assembly 300 may further include a third cell array 203 including the plurality of battery cells 100 and disposed adjacent to the second cell array 202. In addition, the cell assembly 300 may further include a second separation space S2 formed between the second cell array 202 and the third cell array 203.

The extinguishing member 600 may be disposed between the second cell array 202 and the third cell array 203. That is, the extinguishing member 600 may be disposed in the second separation space S2. In other words, the second cell array 202 and the third cell array 203 may be defined as cell arrays 200 disposed on both sides of the extinguishing member 600.

Details of the extinguishing member 600 will be described below with reference to FIGS. 4 and 5.

According to an embodiment, the battery pack 10 may further include an intervening member 700 disposed between the pack housing 11 and the cell assembly 300. The intervening member 700 may have a plate shape. The intervening member 700 may be disposed to face the bottom plate of the pack housing 11.

If the battery pack 10 additionally includes the intervening member 700, the insulating member 400 may be separated from the intervening member 700. Therefore, when the battery is disassembled, the cell assembly 300 may be easily disassembled from the intervening member 700.

The intervening member 700 may be disposed between the pack housing 11 and the cell assembly 300. For example, if a first thermal blocking member and a first electrode connecting member are disposed between the pack housing 11 and the cell assembly 300, the first thermal blocking member and the first electrode connecting member may be collectively referred to as the intervening member 700. That is, the intervening member 700 may include at least one of the first thermal blocking member and the first electrode connecting member. The first thermal blocking member may include a material having at least one of flame retardancy, heat resistance, heat insulation, and insulation. Here, heat resistance may refer to the properties of not melting and not changing shape even at a temperature of 300 degrees Celsius or higher, and heat insulation may refer to the properties of having a thermal conductivity of 1.0 W/mK or lower. In order to secure higher insulation, the thermal conductivity may also have a value of 0.5 W/mK or lower, or 0.3 W/mK or lower. Flame retardancy refers to the properties of preventing or suppressing spontaneous combustion when a fire source is removed and may mean, for example, a rating of V-0 or higher in the UL94 V Test. Insulation may refer to the properties of making it difficult to conduct electricity and may refer to, in a 400V battery pack system, a material, for example, belonging to the comparative tracking index (CTI) II group with a voltage of 400V or higher.

For example, the first thermal blocking member may include at least some of mica, silica, silicate, graphite, alumina, ceramic wool, or aerogel, capable of preventing heat and/or flame propagation. However, the material of the first thermal blocking member is not limited thereto and any known material may be used as long as it may maintain a shape thereof in the event of thermal runaway of the battery cell 100 and prevent heat or flames from spreading to other adjacent battery cells 100. Also, the first thermal blocking member may be formed as an insulating sheet, but it may also be provided as an insulating pad.

The first thermal blocking member may prevent the spread of thermal runaway in the event of thermal runaway. In particular, in the event of a thermal runaway, venting gas may be discharged externally through the bottom plate 11a, thereby preventing heat from spreading to other battery cells 100 by venting gas flowing within the bottom plate 11a. The first electrode connecting member may be electrically connected to the battery cell 100 and serve as a current path.

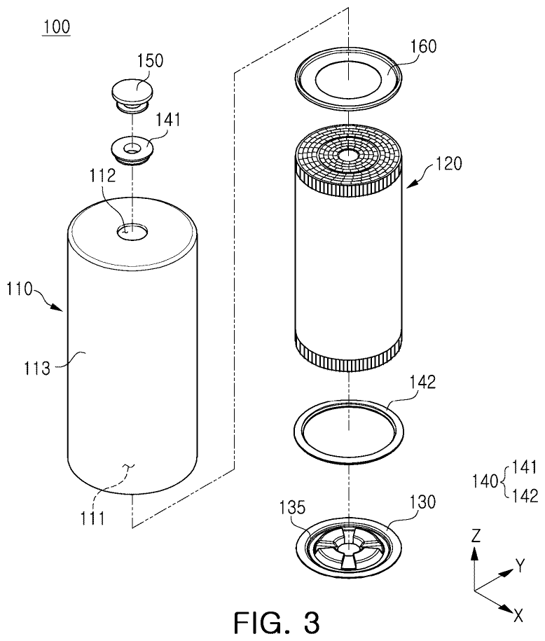

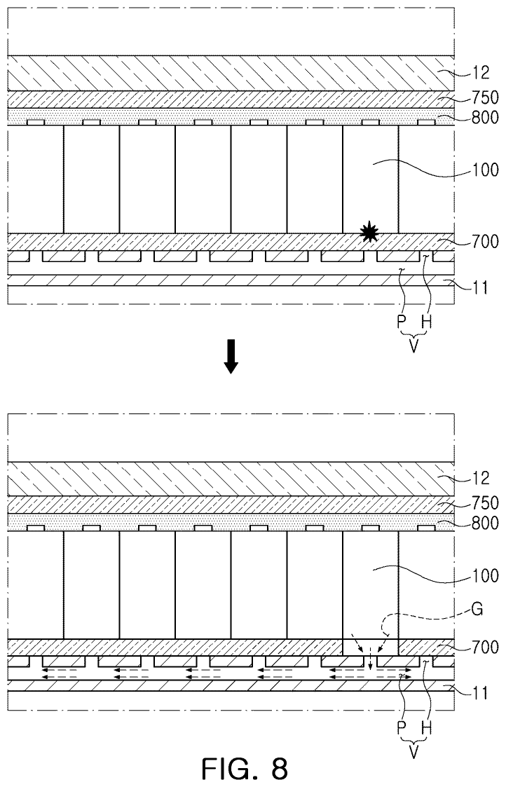

The intervening member 700 may include a notch groove 710 that may be ruptured by venting gas discharged from within the battery cell 100 in the event of a thermal runaway. Therefore, in the event of a thermal runaway, the venting gas may rupture a cell notch portion (135 of FIG. 3) of the cap plate (130 of FIG. 3) and the notch groove 710 of the intervening member 700 and may be discharged externally through the venting hole H and a venting flow path (P of FIG. 8), thereby preventing the spread of thermal runaway to adjacent battery cells 100.

According to an embodiment, the battery pack 10 may include a second electrode connecting member 800 electrically connected to the battery cell 100. Specifically, the second electrode connecting member 800 may be disposed between the cell assembly 300 and the pack cover 12 and electrically connected to a terminal portion of the battery cell 100. Therefore, the second electrode connecting member 800 may serve as a passage for current flow.

The second electrode connecting member 800 may include an electrically conductive busbar electrically connected to a terminal portion and an electrically insulating support plate supporting the busbar. The busbar may include a metal having excellent electrical conductivity. For example, the busbar may include a copper alloy, an aluminum alloy, a nickel alloy, or the like. The support plate may include an electrically insulating synthetic resin.

In an embodiment, the battery pack 10 may additionally include a second thermal blocking member 750 preventing heat generated by the cell assembly 300 from being transferred. The second thermal blocking member 750 may be disposed between the cell assembly 300 and the pack cover 12. Alternatively, the second thermal blocking member 750 may be disposed between the second electrode connecting member 800 and the pack cover 12. Accordingly, heat generated by the cell assembly 300 may be prevented from being transferred to an upper portion of the battery pack 10. For example, when the battery pack 10 is disposed in a lower portion of a battery system, the second thermal blocking member may prevent heat from being transferred to an occupant of the battery system. As an example, the battery system may be a vehicle (see 1 in FIG. 12), but is not limited thereto, and may be used in various transportation means, such as aircraft.

The properties and materials of the second thermal blocking member 750 may be the same as those of the first thermal blocking member.

According to an embodiment, the battery pack 10 may further include a fixing member 900 fixing the cell assembly 300. The fixing member 900 may extend in the first direction. The fixing member 900 may be disposed between the cell assembly 300 and the side plate 11b of the pack housing 11 to secure the cell assembly 300 to not move within the pack housing 11.

FIG. 3 is an exploded perspective view of the battery cell 100 according to an embodiment.

Referring to FIG. 3, the battery cell 100 of the present disclosure may include a cell case 110 accommodating an electrode assembly 120 through an opening 111, a cap plate 130 coupled to the opening 111 of the cell case 110, a terminal portion 150 electrically connected to the electrode assembly 120, and a current collecting plate 160 electrically connecting the terminal portion 150 to the electrode assembly 120.

The electrode assembly 120 may be configured such that positive and negative electrode plates, with wide surfaces thereof facing each other, are stacked with a separator interposed therebetween.

The separator may be configured to prevent an electrical short-circuit between the positive and negative electrode plates and to facilitate ion flow. For example, the separator may include a porous polymer film or a porous nonwoven fabric. In addition, the electrode assembly may be accommodated as various types, such as a jelly roll type formed by winding in a predetermined direction, a stacking type, a zigzag folding type, or a stack-folding type, in the cell case.

The cell case 110 may form at least a portion of the exterior of the battery cell 100. According to an embodiment, the cell case 110 of the present disclosure may be formed to have a cylindrical shape with the opening 111. In this case, an outer surface of the cylindrical cell case may be referred to as a side surface 113 of the battery cell. The cell case 110 may include an internal space in which components (e.g., the electrode assembly 120) of the battery cell 100 are accommodated. According to an embodiment, the opening 111 may be formed in a lower portion of the cell case 110, and the cap plate 130 may be coupled to the opening 111. A terminal hole 112 in which the terminal portion 150 is disposed may be formed in an upper portion of the cell case 110. The terminal portion 150 may be inserted into the internal space of the cell case 110 through the terminal hole 112 and electrically connected to the electrode assembly 120 via the current collecting plate 160. While the drawing illustrates that the opening 111 is formed in the lower portion of the cell case 110 and the terminal hole 112 is formed in the upper portion, this is merely an example, and the opening 111 may be formed in the upper portion of the cell case 110 and the terminal hole 112 may be formed in the lower portion. In other words, if the terminal hole 112 in which the terminal portion 150 is disposed and the cap plate 130 sealing the opening 111 are disposed opposite to each other, both may fall within the scope of the present disclosure.

The cap plate 130 may form at least a portion of the exterior of the battery cell 100. The cap plate 130 may be coupled to the cell case 110 to seal the opening 111 formed in the cell case 110. In an embodiment, the cap plate 130 may be inserted at least partially into the opening 111 of the cell case 110 and then coupled to the cell case 110 to an inner circumferential surface of the cell case 110 by welding or crimping. In an embodiment, the cap plate 130 may be provided to support the electrode assembly 120.

Furthermore, in an embodiment, the cap plate 130 may include a cell venting portion 135 configured to rupture when the internal pressure of the cell case 110 increases, thereby allowing gas or flames within the internal space to be discharged. The cell venting portion 135 may be formed thinner than adjacent portions or may be notched, etc., so as to rupture before the surrounding portions when the internal pressure of the cell case 110 increases. The cell venting portion 135 may rupture due to the pressure within the internal space of the cell case 110, thereby providing a passage for internal gas or flames to escape. In this manner, the cell venting portion 135 may relieve the internal pressure before the battery cell 100 explodes due to increased pressure, while guiding internal flames or gas to be vented in a predetermined direction.

The terminal portion 150 may provide a path for transmitting current to the outside of the battery cell 100. The terminal portion 150 may electrically connect an external power source of the battery cell 100 to the electrode assembly 120. For example, the terminal portion 150 may be coupled to the current collecting plate 160, which is electrically connected to the electrode assembly 120, by welding or other methods. According to an embodiment, the respective terminal portions 150 of the plurality of battery cells 100 may be electrically connected to each other through a separate component, such as a busbar (an external busbar, not shown).

Furthermore, according to an embodiment, the terminal portion 150 may be at least partially inserted into the terminal hole 112 so as to be mounted on the cell case 110. For example, the terminal portion 150 may be coupled to the cell case 110 by a method, such as riveting.

The current collecting plate 160 may be disposed between an upper surface of the cell case 110 having the terminal hole 112 formed therein and the electrode assembly 120. The current collecting plate 160 may include an electrically conductive material, such as metal, and may electrically connect the electrode assembly 120 and the terminal portion 150 to each other. For example, the current collecting plate 160 may be welded to the electrode assembly 120 and the terminal portion 150 to connect them to each other, thereby forming a current path between the electrode assembly 120 and the terminal portion 150. Meanwhile, in an embodiment not shown, the current collecting plate 160 may also be additionally disposed between the cap plate 130 and the electrode assembly 120 to electrically connect them to each other. Through this, a first electrode of the electrode assembly 120 may be connected through the terminal portion 150, and a second electrode opposite to the first electrode may be connected through the cap plate 130. However, this is merely an embodiment, and the first electrode of the electrode assembly 120 may be connected to the terminal portion 150, and the second electrode may be connected to the cell case 110.

The battery cell 100 of the present disclosure may further include a gasket 140. Gaskets 141 and 142 may further include a first gasket 141 disposed between the cell case 110 and the terminal portion 150 and a second gasket 142 disposed between the cell case 110 and the cap plate 130. The first gasket 141 and the second gasket 142 may include an electrically insulating material, such as rubber, to insulate adjacent components from each other so that current may not flow therebetween. In other words, the first gasket 141 may insulate the cell case and the terminal portion 150 from each other, preventing current flow therebetween, and the second gasket 142 may insulate the cell case and the cap plate 130 from each other, preventing current flow therebetween.

According to the present disclosure, the first electrode of the electrode assembly 120 may be electrically connected to the terminal portion 150, and the second electrode may be electrically connected to either the cell case or the cap plate 130. Here, the first electrode may be any one of the positive or negative electrode, and the second electrode may be the other. However, the present disclosure is not limited thereto.

FIG. 4 is a top plan view of the battery pack 10 excluding the pack cover 12 according to an embodiment. FIG. 5 is a side view of the battery cell 100 and an insulating member 400 according to an embodiment.

The descriptions of the battery cell 100, the cell array 200, the cell assembly 300, and the insulating member 400 of FIGS. 1 through 3 may also be applied to the battery cell 100, the cell array 200, the cell assembly 300, and the insulating member 400 of FIGS. 4 and 5.

Referring to FIG. 4, according to an embodiment, the cell assembly 300 may include a plurality of cell arrays 200. For example, the cell assembly 300 may include a first cell array 201 and a second cell array 202 adjacent to each other.

According to an embodiment, the cell assembly 300 may include a third cell array 203 including a plurality of battery cells 100 and disposed adjacent to the second cell array 202.

The first cell array 201, the second cell array 202, and the third cell array 203 may be arranged in the order of the first cell array 201, the second cell array 202, and the third cell array 203 in the +X−direction.

According to an embodiment, the cell assembly 300 may include a separation space S formed between the cell arrays 200. The separation space S may include a first separation space S1 formed between the first cell array 201 and the second cell array 202 and a second separation space S2 formed between the second cell array 202 and the third cell array 203. Thus, according to an embodiment, the cell assembly 300 may include the first separation space S1 formed between the first cell array 201 and the second cell array 202 and the second separation space S2 formed between the second cell array 202 and the third cell array 203.

The insulating member 400 may be disposed in the first separation space S1. Specifically, the insulating member 400 may be disposed to fill the first separation space S1. The insulating member 400 may be disposed to partially fill the first separation space S1 in the third direction (Z). Specifically, the first separation space S1 may include an empty space between a portion in which the insulating member 400 is disposed and the pack housing 11. In other words, the insulating member 400 may be disposed to be spaced apart from the pack housing 11.

In addition, the insulating member 400 may have a shape of filling the first separation space S1 in a cross-section (an X-Y plane), perpendicular to the height direction (the third direction, Z) of the battery cells. More specifically, the insulating member 400 may have a shape of completely filling the first separation space S1 in the cross-section (the X-Y plane), perpendicular to the height direction (third direction, Z) of the battery cells.

The insulating member 400 may be disposed so as to contact a portion of the side surface (113 in FIG. 3) of the battery cell 100 between the first cell array 201 and the second cell array 202. Specifically, the insulating member 400 may be disposed so as to contact a portion of the side surface (113 in FIG. 3) of the battery cell 100 in the third direction. In addition, the insulating member 400 may be disposed so as to be spaced apart from the pack housing 11 or the intervening member 700. That is, the insulating member 400, which is disposed to contact a portion of the side surface (113 in FIG. 3) of the battery cell 100 in the third direction and spaced apart from the pack housing 11 or the intervening member 700, may be disposed to fully contact the side surface (113 in FIG. 3) of the battery cell 100 in the plane (the X-Y plane), perpendicular to the third direction.

The insulating member 400 may include a material having both insulating and non-curing properties. Insulating properties may refer to a quality of thermal conductivity of 1.0 W/mK or less. To ensure even higher insulating properties, the thermal conductivity may be 0.5 W/mK or less, or even 0.3 W/mK or less. Non-curing properties may refer to a quality with low hardness and high viscosity, facilitating processing and molding. For example, non-curing properties may refer to a quality in which the hardness is less than Shore 0070 when measured by American Society for Testing and Materials (ASTM) D2240 and the viscosity is 100,000 Pa·s or more when measured at 1/s at 25° C. by ASTM D2196. If the viscosity is less than 1 Pa·s, the shape may not be maintained and may be deformed. If the viscosity exceeds 10 Pa·s, molding may be difficult and shape deformation due to pressurization may be difficult. Therefore, the insulating member 400 according to the present disclosure may prevent heat transfer between the battery cells 100 and enable the battery pack 10 to be easily disassembled into the battery cells 100 when the lifespan of the battery is over.

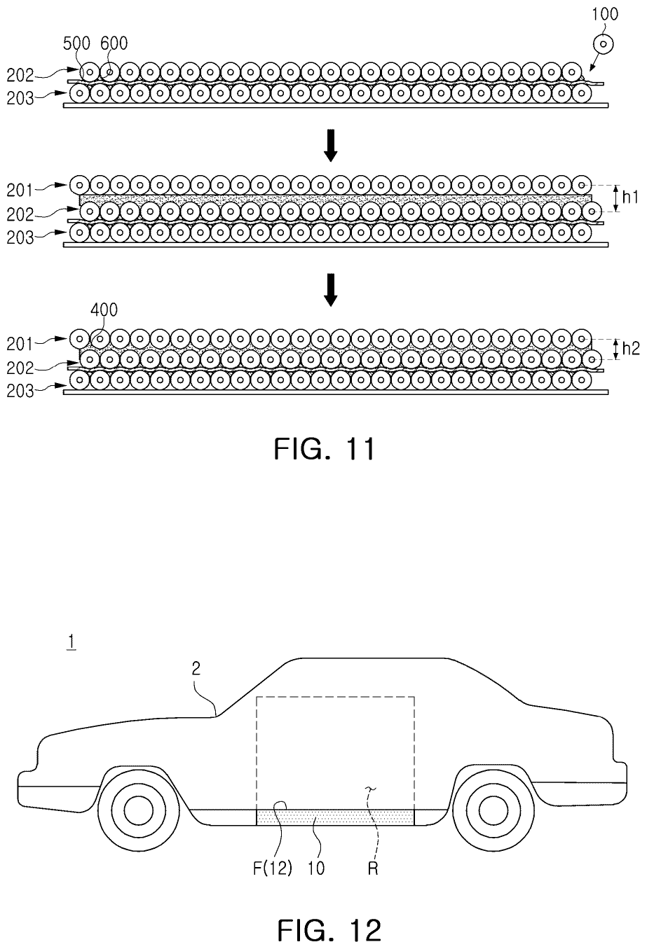

Details of the material of the insulating member 400 will be described below with reference to FIG. 11.

According to an embodiment, the cooling member 500 may be configured to conduct heat generated by the plurality of battery cells 100 for cooling thereof. The cooling member 500 may include a plurality of cooling channels therein. The cooling channels may include a cooling material, such as a refrigerant. Alternatively, the cooling member 500 may be configured such that an externally cooled cooling agent is injected into the cooling channels and a heated cooling material is discharged externally. In other words, the cooling member 500 may have a structure in which a cooling material circulates to perform cooling. However, the specific structure of the cooling member 500 is not limited, and any structure capable of cooling adjacent battery cells 100 may be included within the present disclosure.

According to an embodiment, the cooling member 500 may be disposed between the second cell array 202 and the third cell array 203 to contact the side surface of the battery cell 100.

Through this, the cooling member 500 may cool a plurality of adjacent battery cells 100.

The cooling member 500 may have a wave shape or an “S” shaped plate shape to maximize contact with the side surface of the battery cell 100. The cooling member 500 may have a shape extending in the first direction in which the plurality of battery cells 100 are arranged.

The extinguishing member 600 may be configured to release an internal extinguishing agent 602 when a fire occurs in the cell assembly 300. Therefore, in the event of a fire in the battery cells 100, the extinguishing member 600 may extinguish the fire at an early stage and prevent the fire from spreading to adjacent battery cells 100. For example, the extinguishing member 600 may include a case 601 including an internal accommodation space and the extinguishing agent 602 accommodated in the accommodation space.

The case 601 may be formed of a material having a melting point of 100° C. or higher, 160° C. or higher, 180° C. or higher, or 250° C. or higher. Therefore, the case 601 may not melt under the general high temperature conditions (approximately 80° C.) of the battery cell 100, but may only melt under abnormally high temperatures.

For example, the case 601 may include at least one of polypropylene (PP), polyethylene (PE), polystyrene (PS), acrylonitrile butadiene styrene (ABS), polyvinyl chloride (PVC), polyoxymethylene (POM), polytetrafluoroethylene (PTFE), phenol formaldehyde (PF), epoxy (EP), and polyurethane (PU).

The extinguishing agent 602 may be a material exhibiting at least one of a negatively catalytic effect, a suffocating effect, or a cooling effect. The negatively catalytic effect may refer to slowing or inhibiting a chemical reaction. The suffocating effect may refer to stopping combustion by blocking the oxygen supply during a fire suppression or extinguishing process. The cooling effect may refer to lowering the temperature by absorbing or removing heat during a fire suppression process. Therefore, in a thermal runaway situation, the extinguishing agent 602 may prevent the event situation of the battery cell 100 from spreading to adjacent battery cells 100.

The extinguishing agent 602 is included in the present disclosure, regardless of the properties or extinguishing principle thereof, as long as it is the extinguishing agent 602 generally used for fire suppression. For example, the extinguishing agent 602 may include at least one of potassium carbonate, ammonium carbonate, urea, primary ammonium phosphate, secondary ammonium phosphate, tertiary ammonium phosphate, and purified water.

In an embodiment, the extinguishing agent 600 may be disposed in the first separation space S1. That is, the extinguishing agent 600 may be disposed between the first cell array 201 and the second cell array 202, together with the insulating member 400. By arranging the extinguishing member 600 and the insulating member 400 together, the structural efficiency of the battery pack 10 may be improved.

According to an embodiment, the extinguishing member 600 may be disposed in the second separation space S2 formed between the second cell array 202 and the third cell array 203. That is, the extinguishing member 600 may be disposed together with the cooling member 500 between the second cell array 202 and the third cell array 203. Arranging the extinguishing member 600 and the cooling member 500 together may improve the structural efficiency of the battery pack 10.

The extinguishing member 600 may include a plurality of extinguishing members 600 arranged in the first separation space S1 or the second separation space S2. The extinguishing member 600 may have a shape extending in the third direction.

The fixing member 900 may secure the cell assembly 300 not to move within the pack housing 11. Accordingly, the stability of the battery pack 10 may be improved.

According to an embodiment, the fixing member 900 may be disposed between the outermost cell array 200 of the cell assembly 300 and the side plate 11b of the pack housing 11. Accordingly, the cell assembly 300 may not move and may be secured within the pack housing 11.

A cooling member 500 may be disposed between the outermost cell array 200 of the cell assembly 300 and the cell array 200 adjacent to the outermost cell array 200 of the cell assembly 300. Accordingly, the outermost cell array 200 of the cell assembly 300 may be cooled.

The fixing member 900 may be formed of metal or plastic. If the fixing member 900 is formed of metal, the fixing member 900 may be manufactured using a die casting method. If the fixing member 900 is formed of plastic, the fixing member 900 may be manufactured using an injection molding method.

Referring to FIG. 5, according to an embodiment, the battery cell 100 may include a first edge L1 adjacent to the terminal portion 150 on one side of the battery cell 100 and a second edge L2 located on the other side of the battery cell 100. The side surface 113 of the battery cell 100 may include a first region A1 adjacent to the first edge L1, a second region A2 adjacent to the second edge L2, and a third region A3 located between the first region A1 and the second region A2.

The insulating member 400 may be disposed in the third region A3. Therefore, the cell assembly 300 may be easily separated from the pack housing 11.

In addition, the insulating member 400 may be connected in the first direction in which the battery cells 100 are arranged. Therefore, the area of the insulating member 400 in contact with the side surface 113 of the battery cell 100 may increase, thereby effectively blocking heat transfer. Specifically, the insulating member 400 may be disposed to extend in the third region A3 of the cell array 200 in which the plurality of battery cells 100 are arranged in the first direction. Therefore, when the battery cell 100 is accommodated in the pack housing 11, the insulating member 400 may be disposed to be spaced apart from the pack housing 11. In this case, the cell assembly 300 effectively blocks heat transfer, while being easily separated from the pack housing 11, thereby improving the reusability of the battery pack 10.

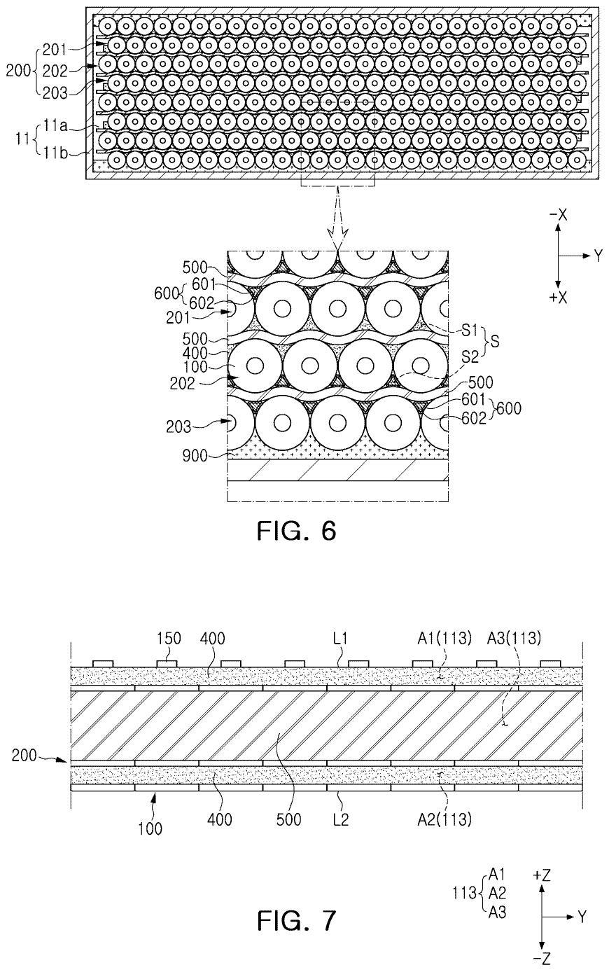

FIG. 6 is a top plan view of the battery pack 10 without the pack cover 12 according to another embodiment. FIG. 7 is a side view of the battery cell 100, the insulating member 400, and the cooling member 500 according to another embodiment.

The differences of the other embodiments of FIGS. 6 and 7 from those of the embodiments of FIGS. 4 and 5 will be mainly described.

Referring to FIG. 6, the cooling member 500 may be disposed to contact the side surface of the battery cell 100 between the first cell array 201 and the second cell array 202. Accordingly, the cooling member 500 may cool a plurality of adjacent battery cells 100.

That is, the cooling member 500 may be disposed together with the insulating member 400 between the first cell array 201 and the second cell array 202. By arranging the cooling member 500 and the insulating member 400 together, the structural efficiency of the battery pack 10 may be improved. Referring to FIG. 7, the cooling member 500 may be disposed in the third region A3. In addition, the cooling member 500 may be connected in the first direction. Specifically, the cooling member 500 may be disposed in the third region A3 and extend in the first direction in the cell array 200 in which the plurality of battery cells 100 are arranged in the first direction.

The insulating member 400 may be disposed in at least one of the first region A1 and the second region A2 of the side surface 113 of the battery cell 100. For example, the insulating member 400 may be disposed to extend in the first direction in the first region A1 and the second region A2 of the plurality of battery cells 100 arranged in the first direction. That is, by disposing the insulating member 400 and the cooling member 500 together, the structural efficiency of the battery pack 10 may be improved.

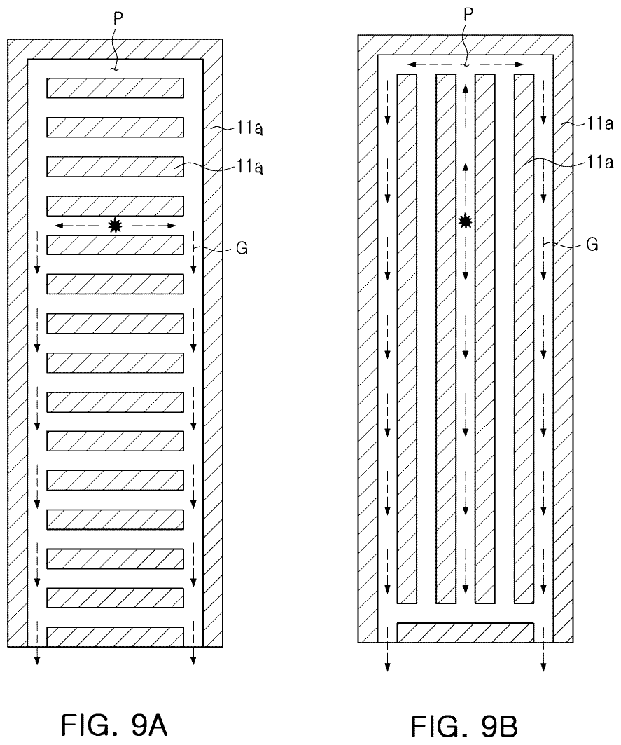

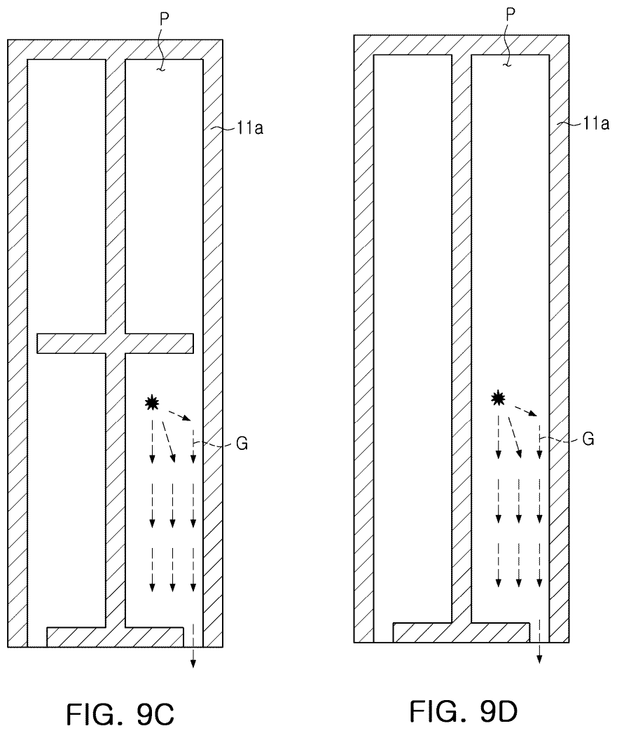

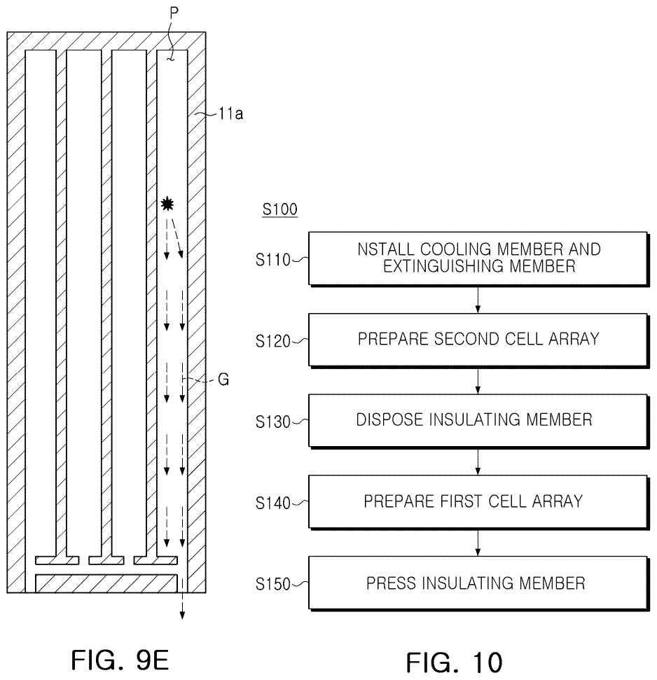

FIG. 8 is a partial cross-sectional view of the battery pack 10 when an event occurs. FIGS. 9A to 9E are cross-sectional views of the bottom plate 11a according to various embodiments.

FIG. 8 illustrates an event, such as thermal runaway, occurring in at least one of the plurality of battery cells 100.

Referring to FIG. 8, in the battery cell 100 in which an event has occurred, the cell notch portion (135 in FIG. 3) of the cap plate (130 in FIG. 3) may rupture as internal pressure increases. As the cell notch portion (135 in FIG. 3) may rupture, the notch groove 710 of the intervening member 700 disposed between the cell assembly 300 and the pack housing 11 may also rupture. Therefore, at least one of gas, flames, and particles may be vented through the ruptured cap plate (130 in FIG. 3) and the intervening member 700.

In the drawing, “G” includes at least one of gas, flames, and particles vented from the battery cell 100 and is referred to as “venting gas” for convenience of description.

According to an embodiment, the pack housing 11 may include a venting portion V discharging gas generated inside the battery cell 100 externally. Therefore, the venting gas G generated within the battery cell 100 may be rapidly discharged externally, thereby preventing an event situation in one battery cell 100 from spreading to an adjacent battery cell 100.

According to an embodiment, the venting portion V may include a venting hole H formed on one surface of the floor plate 11a and a venting flow path P formed between one surface and the other surface of the floor plate 11a. Therefore, the venting gas G may be vented to a lower surface of the cell assembly 300, thereby preventing direct heat transfer to a passenger compartment (R in FIG. 12) located above the battery pack 10.

The one surface of the floor plate 11a may refer to a surface facing the cell assembly 300, and the other surface thereof may refer to a surface opposite to the one surface.

Referring to FIGS. 9A to 9E, various shapes of the venting flow path P formed between one surface of the bottom plate 11a facing the cell assembly 300 and the other surface located opposite to the one surface may be identified.

The venting flow path P may refer to an empty space formed between one surface and the other surface of the bottom plate 11a. Therefore, when an event occurs, venting gas generated in the battery cells 100 may be discharged externally through the empty space.

The weight of the battery pack 10 may be reduced as the volume occupied by the venting flow path P within the bottom plate 11a increases. Conversely, as the volume occupied by the venting flow path P decreases, the structural robustness of the battery pack 10 may be improved.

Therefore, designers may select an appropriate shape of the venting flow path P by considering the weight and structural robustness of the battery pack 10.

FIG. 10 is a flowchart of a method (S100) of manufacturing a battery pack according to an embodiment. FIG. 11 is a schematic diagram schematically illustrating the method (S100) of manufacturing a battery pack according to an embodiment.

Referring to FIGS. 10 and 11, the method (S100) of manufacturing a battery pack according to the present disclosure may include a second cell array preparation operation (S120) of arranging the plurality of battery cells 100 to prepare the second cell array 202, an insulating member arrangement operation (S130) of arranging the insulating members 400 on the side surfaces (113 of FIG. 3) of the plurality of battery cells 100 included in the second cell array 202, a first cell array preparation operation (S140) of arranging the plurality of battery cells 100 on the insulating member 400 to prepare the first cell array 201, and an insulating member pressing operation (S150) for pressing the insulating member 400.

According to an embodiment, the second cell array preparation operation (S120) may refer to arranging the plurality of battery cells 100 in one direction (e.g., the first direction) to form the second cell array 202.

The insulating member arrangement operation (S130) may refer to applying the insulating member 400 to one side of the second cell array 202. Specifically, the insulating member arrangement operation (S130) may refer to applying the insulating member 400 to the side surface (113 in FIG. 3) of the plurality of battery cells 100 arranged in the first direction. While the drawing illustrates only the application of the insulating member 400, the present disclosure is not limited thereto, and in order to manufacture the battery pack 10 according to another embodiment, the cooling member 500 or the extinguishing member 600 may be arranged together with the insulating member 400 on the side surface of the battery cell 100.

Here, according to an embodiment, the insulating member 400 may include an insulating and non-curing material. Insulating may refer to a thermal conductivity of 1.0 W/mK or less. To achieve higher insulation, the thermal conductivity may be 0.5 W/mK or less, or even 0.3 W/mK or less. Non-curability may refer to a quality of being soft and having high viscosity so as to be easily processed and molded. Therefore, the insulating member 400 according to the present disclosure may prevent heat transfer between battery cells 100 and allow the battery pack 10 to be easily disassembled into the battery cells 100 when the lifespan of the battery lifespan is over.

For example, the insulating member 400 may be provided as a non-curing pad. In this case, the insulating member 400 may include at least one of polyurethane (PU) and silicone to achieve non-curing properties. In addition, the insulating member 400 may include at least some of mica, silica, silicate, graphite, alumina, ceramic wool, or aerogel as a filler for insulation properties. The filler may be of a particle or woven type.

Preferably, the hardness of the insulating member 400 may be less than Shore 0070 when measured by the ASTM (American Society for Testing and Materials) D2240.

The first cell array 201 preparation operation (S140) may refer to arranging the battery cells 100 in one direction on one surface of the insulating member 400 to form the first cell array 201. That is, the first cell array 201 may be arranged such that the insulating member 400 is disposed between the first cell array 201 and the second cell array 202.

The insulating member pressing operation (S150) may refer to pressing the first cell array 201 to press the insulating member 400. The insulating member 400 may be deformed under pressure. Therefore, in the insulating member pressing operation (S150), a gap between the first cell array 201 and the second cell array 202 may be reduced. In other words, a distance h1 between the first cell array 201 and the second cell array 202 before pressing may be greater than a distance h2 between the first cell array 201 and the second cell array 202 after pressing.

The pressed insulating member 400 may be formed to fill the first separation space S1 in the cross-section, perpendicular to the height direction of the battery cell 100, between the first cell array 201 and the second cell array 202. The pressed insulating member 400 may have a shape of completely filling the first separation space S1 in the cross-section, perpendicular to the height direction of the battery cell 100. Accordingly, the contact area with the side surface (113 in FIG. 3) of the battery cell 100 may increase, as compared to a case in which the first separation space S1 is not completely filled in the cross-section, perpendicular to the height direction of the battery cell, thereby increasing the insulation performance.

According to an embodiment, the method (S100) of manufacturing a battery pack may further include a cooling member and extinguishing member installation operation (S110) of installing the cooling member 500 cooling the battery cell 100 and the extinguishing member 600 extinguishing a fire in the battery cell 100. The cooling member and extinguishing member installation operation (S110) may be performed before the second cell array preparation operation (S120). That is, after the cooling member 500 and the extinguishing member 600 are arranged in the third cell array 203 in which the plurality of battery cells 100 are arranged, the second cell array 202 may be arranged on one surface of the cooling member 500.

Specifically, the extinguishing member 600 may be disposed between the battery cell 100 of the third cell array 203 and an adjacent battery cell 100 of the third cell array 203. The cooling member 500 may be disposed on one side of the third cell array 203. The battery cell 100 of the second cell array 202 may then be installed on one surface of the cooling member 500 together with the extinguishing member 600.

The second cell array 202 may be disposed so that the cooling member 500 is disposed between the second cell array 202 and the third cell array 203. Accordingly, the cooling member 500 may cool a plurality of adjacent cell arrays 200.

To secure the extinguishing member 600 between adjacent battery cells 100, an adhesive may be applied to the side surface (113 in FIG. 3) of the battery cell 100. The adhesive may be non-curable to enhance recyclability. Non-curability may refer to a quality of being soft and having high viscosity so as to be easily processed and molded. The adhesive may be applied in a spray form to minimize the usage amount. Alternatively, the adhesive may be applied in a slot die or dispensed form to ensure sufficient adhesion.

That is, the extinguishing member 600 may be disposed on the third cell array 203 in a state in which the adhesive is applied. After the cooling member 500 is disposed, the extinguishing member 600 may be arranged together with the second cell array 202 and may be disposed between the second cell array 202 and the third cell array 203.

FIG. 12 is a side view of a vehicle 1 according to an embodiment.

While FIG. 12 illustrates the vehicle 1 as a battery system, the battery system of the present disclosure may be applied to various fields, including aircraft.

The description of the battery pack 10 of FIGS. 1 to 11 may be equally applied to the battery pack 10 of FIG. 12.

A battery system according to an embodiment of the present disclosure may include the battery pack 10 and a body 2 forming a passenger compartment R.

According to an embodiment, the battery pack 10 may include the cell assembly 300 including the first cell array 201 and the second cell array 202 including the plurality of battery cells 100 arranged in a row, the pack housing 11 accommodating the cell assembly 300, the pack cover 12 covering the cell assembly 300, and the insulating member 400 disposed to contact the side surface 103 of the battery cells 100 between the first cell array 201 and the second cell array 202. The insulating member 400 may be separated from the pack housing 11.

According to an embodiment, the pack cover 12 of the battery pack 10 may be provided as at least a portion of the body 2. For example, the pack cover 12 may be provided as the floor of the passenger compartment R. That is, in the present disclosure, a cell-to vehicle (CTV) structure integrating the pack cover 12 and the floor F of the passenger compartment R, thereby reducing the weight of the battery system. The reduced weight of the battery system may increase a driving range of the battery system.

According to an embodiment of the present disclosure, the battery pack having improved recyclability may be provided.

According to an embodiment of the present disclosure, the structurally simplified battery system may be provided.

Only specific examples of implementations of certain embodiments are described. Variations, improvements and enhancements of the disclosed embodiments and other embodiments may be made based on the disclosure of this patent document.

What is claimed is:

1. A battery pack comprising:
a cell assembly including a first cell array and a second cell array, respectively including a plurality of battery cells arranged in a row;
a pack housing accommodating the cell assembly;
a pack cover covering the cell assembly; and
an insulating member disposed to contact a side surface of a battery cell of the plurality of battery cells between the first cell array and the second cell array,
wherein the insulating member is separated from the pack housing.

2. The battery pack of claim 1, wherein the insulating member is spaced apart from the pack housing.

3. The battery pack of claim 2, wherein the battery cell includes a first edge adjacent to a terminal portion on one side of the battery cell and a second edge located on the other side of the battery cell, the side surface of the battery cell includes a first region adjacent to the first edge, a second region adjacent to the second edge, and a third region located between the first region and the second region, and the insulating member is disposed in the third region.

4. The battery pack of claim 1, wherein the cell assembly includes a first separation space formed between the first cell array and the second cell array, and the insulating member is disposed in the first separation space.

5. The battery pack of claim 1, further comprising:
an intervening member disposed between the pack housing and the cell assembly,
wherein the insulating member is separated from the intervening member.

6. The battery pack of claim 5, wherein the pack housing includes a venting portion discharging gas generated inside the battery cell externally, and the intervening member includes a notch groove.

7. The battery pack of claim 6, wherein
the pack housing includes a bottom plate and a plurality of side plates extending from an edge of the bottom plate toward the pack cover, and
the venting portion includes a venting hole formed on one surface of the bottom plate and a venting flow path formed between one surface and the other surface of the bottom plate.

8. The battery pack of claim 1, further comprising:
at least one cooling member cooling the cell assembly,
wherein the first cell array and the second cell array are arranged to be in contact with the at least one cooling member.

9. The battery pack of claim 8, wherein the cooling member is disposed to contact the side surface of the battery cell between the first cell array and the second cell array.

10. The battery pack of claim 9, wherein
the battery cell includes a first edge adjacent to a terminal portion on one side of the battery cell and a second edge located on the other side of the battery cell,
the side surface of the battery cell includes a first region adjacent to the first edge, a second region adjacent to the second edge, and a third region located between the first region and the second region,
the cooling member is disposed in the third region, and
the insulating member is disposed in at least one of the first region and the second region.

11. The battery pack of claim 1, further comprising an extinguishing member disposed inside the pack housing and extinguishing a fire in the battery cell.

12. The battery pack of claim 11, wherein
the extinguishing member includes:
a case including an accommodation space; and
an extinguishing agent accommodated in the accommodation space.

13. The battery pack of claim 11, wherein the cell assembly further includes a third cell array including a plurality of battery cells and disposed adjacent to the second cell array and a second separation space formed between the second cell array and the third cell array, and the extinguishing member is disposed in the second separation space.

14. The battery pack of claim 1, wherein the insulating member includes an insulating and non-curing material.

15. A method of manufacturing a battery pack, the method comprising:
a second cell array preparation operation of arranging a plurality of battery cells to prepare a second cell array;
an insulating member arrangement operation of disposing an insulating member on a side surface of the plurality of battery cells included in the second cell array;
a first cell array preparation operation of arranging a plurality of battery cells on the insulating member to prepare a first cell array; and
an insulating member pressing operation of pressing the insulating member.

16. The method of claim 15, wherein the insulating member is disposed in a first separation space formed between the first cell array and the second cell array.

17. The method of claim 15, wherein the insulating member pressing operation reduces a gap between the first cell array and the second cell array.

18. The method of claim 15, further comprising a cooling member and extinguishing member installation operation of installing a cooling member cooling the plurality of battery cells and an extinguishing member extinguishing a fire in the plurality of battery cells.

19. A battery system comprising:
a battery pack; and
a body forming a passenger compartment,
wherein the battery pack includes a cell assembly including a first cell array and a second cell array, respectively including a plurality of battery cells arranged in a row, a pack housing accommodating the cell assembly, a pack cover covering the cell assembly, and an insulating member disposed to contact a side surface of the plurality of battery cells between the first cell array and the second cell array,
wherein the insulating member is separated from the pack housing, and
the pack cover is provided as at least a portion of the body.

20. The battery system of claim 19, wherein the cell assembly includes a first separation space formed between the first cell array and the second cell array, and the insulating member is disposed in the first separation space.
